(19) United States
(12) Patent Application Publication
(10) Pub. No.: US 2026/0236507 A1
(43) Pub. Date: Aug. 13, 2026

(54) MODIFICATION, SHARING, AND QUERYING OF AUTHORITATIVE SOURCE DOCUMENTS

(71) Applicant: FACTIFY TECHNOLOGIES INC., Dover, DE (US)

(72) Inventor: Matan Gavish, Givat Ada (IL)

(21) Appl. No.: 19/639,546

(22) Filed: Apr. 6, 2026

Related U.S. Application Data
(63) Continuation of application No. PCT/US2025/034158, filed on Jun. 18, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 16/334

(52) U.S. Cl. CPC G06F 16/334

(57) ABSTRACT

The aspects described herein pertain at least to a method implemented by a computer for responding to a request addressed to a global marker of an electronic document. The method includes receiving a request addressed to a global marker of an electronic document, processing, by execution of the electronic document, the request, and responding to, by the execution of the electronic document, the request.

### PRIORITY CLAIMS TO RELATED APPLICATIONS

This application is a continuation application of and claims priority to International Patent Application No. PCT/US25/34158 filed Jun. 18, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

Traditional systems for revising and circulating electronic documents rely heavily on modifying documents separately, saving these documents in various locations, and sharing multiple versions of these documents with various users via, e.g., email applications, file sharing servers, and so forth. As a result, several users may have different versions of a particular document with each version being stored in different locations and having content that is partially present or entirely absent from other versions. In other words, the problems associated with incorporating multiple revisions across various versions of paper documents into a single document persist with traditional digital documents. Additionally, traditional systems rely heavily on a number of third party software applications, separate and distinct from the digital documents themselves, to enable sharing, storing, and modification of these documents. These digital documents, while being displayable on various user interfaces, have the same capabilities and properties as paper documents. In short, traditional digital documents are little more than images of their paper document counterparts.

Further, gathering information about digital documents using traditional systems is extremely restrictive, time consuming, and frustrating. Users are required to individually open a particular document or interact with an icon representing the document, e.g., right click on the icon and analyze a limited set of properties, to identify basic information about the document. While some document management systems provide marginally better document search capabilities, the search results provided by these systems may, at best, include a limited amount of additional information such as the file name, the date on which the document was last edited, and the user that last accessed the document.

### SUMMARY

In some aspects, the techniques described herein relate to a computer-implemented method comprising: receiving a request addressed to a global marker of an electronic document, processing, by execution of the electronic document, the request, and responding to, by the execution of the electronic document, the request.

In some aspects, the techniques described herein relate to a system comprising: a document management hub including at least one physical processor and physical memory comprising computer-executable instructions that, when executed by the at least one physical processor, cause the physical processor to: receive a request addressed to a global marker of an electronic document, process, by execution of the electronic document, the request, and respond to, by the execution of the electronic document, the request.

In some aspects, the techniques described herein relate to a non-transitory computer-readable medium comprising computer-executable instructions that, when executed by at least one of one or more processors of a computing device, cause the computing device to: receive a request addressed to a global marker of an electronic document, process, by execution of the electronic document, the request, and respond to, by the execution of the electronic document, the request.

In some aspects, the techniques described herein relate to another method comprising identifying, at a system configured to deduplicate electronic documents, an electronic document having a globally unique identifier, and using, by the system, the globally unique identifier to perform a deduplication operation with respect to the electronic document.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts a structure of a self-determinative document;

FIG. 2 illustrates a system for managing electronic documents as smart digital objects;

FIG. 3 illustrates a flowchart of a method for responding to a request addressed to an electronic document;

FIG. 4 illustrates the electronic document stored in a unique globally addressable location in memory of a device;

FIG. 5A illustrates the electronic document being accessed simultaneously from multiple devices;

FIG. 5B illustrates the near simultaneous display of content modifications on different example cover pages;

FIG. 6A illustrates the electronic document implementing an in-document application (IDA) for facilitating an electronic mail communication exchange;

FIG. 6B illustrates an example cover page responding to the questions sent by an electronic document;

FIG. 6C illustrates sharing a redacted version of answers generated by an example cover page;

FIG. 7 illustrates an example cover page implementing an IDA for facilitating another electronic mail exchange; and

FIG. 8 illustrates a response generated by an example cover page.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

Electronic documents, also referred to as digital documents, encompass any form of document stored or accessed using a computer or digital medium. Common formats for electronic documents include PS, PDF, and XPS, among others. These documents are represented digitally as files stored on local drives, shared networks, or cloud-based systems. However, traditional methods of managing electronic documents often result in a loss of control for individuals and entities. This loss of control occurs whether the documents are shared externally with third parties or kept internally within an organization.

For example, when a company hires a new employee and grants them access to proprietary information, the company effectively relinquishes control over that information, typically in the form of electronic documents such as PDFs, spreadsheets, word processing files, and forms. Instead of maintaining actual control, the company relies on pseudo-control mechanisms, such as policies, procedures, and legal agreements. If the employee leaves the company and improperly retains or uses these documents, the company must resort to enforcing employment agreements through the legal system. This may involve attempting to recover or destroy the documents or seeking damages for any harm caused by the former employee's misuse of the information.

Similar scenarios occur daily in commerce and other professional relationships. The proliferation of electronic documents creates a chaotic environment where control is tenuous at best. The primary safeguard against misuse is the legal system, which provides a mechanism for enforcing contractual obligations when improper activity has a significant impact. However, litigation is often expensive, uncertain, and disruptive, encouraging parties to comply with contractual obligations to avoid legal disputes.

For instance, in an unsuccessful M&A transaction, one party may inadvertently retain trade secrets from the other side after the deal falls apart. While retaining these documents may breach material erasure provisions of a non-disclosure agreement, the party is unlikely to share the trade secrets with outsiders due to ethical considerations and the fear of legal repercussions. This reliance on pseudo-control—where compliance is partial and breaches are minor enough to avoid litigation—represents the best outcome achievable under the current system.

In virtually every arms-length transaction, confidential information is shared with the expectation that the legal system and a general aversion to litigation will prevent significant misuse. Whether paying for a sandwich with a credit card, engaging in banking or investment activities, consulting with an attorney, completing a real estate transaction, or working with an accountant to prepare taxes, parties routinely share sensitive information and rely on pseudo-control mechanisms to protect it. This reliance on goodwill and the legal ecosystem underscores the limitations of the current system.

There is a clear need for a system that provides actual control over electronic documents, eliminating dependence on the goodwill of others and the costly, uncertain, and distracting process of legal enforcement. Such a system would ensure that document security and integrity are maintained without relying on external safeguards, enabling more efficient and reliable management of sensitive information in modern digital environments.

Further, revising and circulating digital documents using traditional systems is tedious, computationally inefficient, and faulty. Digital documents may need to be edited by different users, each of whom may store a revised version of the document locally on their respective devices. As a result, multiple versions of a particular digital document may exist at any given time with each version including content that is partially present or entirely absent from other versions. Problems associated with tracking and correctly incorporating these changes could be exacerbated by data corruption associated with one or more of these versions. Additionally, in traditional systems, issues associated with paper documents are simply transferred to the digital versions of these documents, with the fundamental problems of paper documents persisting. Traditional digital documents are little more than images of their paper counterparts.

The systems and methods disclosed herein address one or more of the challenges identified above by introducing a transformative way of querying and editing digital documents. This approach involves the use of self-determinative documents operating independently and as part of a document management hub to enable multiple authorized users to simultaneously, sequentially, and according to any other order, access, modify, share, and query the document. All of these are possible without storing and circulating multiple versions of the document, utilizing third party software applications to share the document, or expending inordinate amounts of time manually reviewing various parts of the document.

Further, the self-determinative documents described herein are provisioned as digital infrastructure, and as such, include an application programming interface (API) with a set of instructions that, when executed, enable these documents to allow multiple users using different devices to modify instances of these documents. Each of these document instances are directly linked to the sole and authoritative versions of these documents (true versions) via a global marker embedded within both the documents and their respective instances. Modifications to document instances are, automatically and approximately in real time (e.g., within fractions of a second or a few seconds), included as part of the documents themselves.

All documents are stored in unique locations that are addressable and accessible via the global marker that links (1) the documents to the unique storage locations and (2) the various digital instances to the documents. In this way, an unbroken digital chain connects the universe of digital document instances to the digital documents, and the digital documents to their respective unique storage locations. No longer is there a need for multiple versions of documents to be circulated, as any and all changes to document instances of a particular document are automatically propagated to the document, by the document. And the document, either independently or in conjunction with a document management hub, is capable of storing, tracking, and updating all changes made to it as well.

Further, a number of in-document applications software applications that are a part of the documents themselves and which reside in the environment of these documents-enable users to query other documents and gather a large amount of information, in real-time, about them. For example, these in-document applications can enable a user to draft an email or email like correspondence that is directed to a specific document, requesting information about (1) the identity of users that have signed the document, (2) the portions of the documents that were reviewed by various users, (3) time spent reviewing a particular portion, and so forth. Documents can also determine a variety of other types of information about other documents without utilizing third party software applications or leaving the environment of the electronic document.

Self-determinative documents may be designed to maintain control over their lifecycle, access, and interactions, reducing the reliance on pseudo-control mechanisms such as policies, procedures, and legal agreements. By embedding intelligence directly within the document, the embodiments of this disclosure may provide a robust framework for ensuring security, integrity, and compliance, even when documents are shared externally or distributed across various platforms. This embedded intelligence also accesses data related to various parts of these documents to generate a visual layout presentation framework that significantly simplifies the process of identifying a document of interest, thereby resolving the traditional deficiencies relating to document searching.

Further, traditional methods of managing electronic documents often result in a loss of control once the document is shared, as highlighted in the example of a company granting an employee access to proprietary information. The systems and methods disclosed herein may address this problem by provisioning documents with embedded intelligence, such as an integrated API or software chip, which allows the document to autonomously enforce access permissions and track interactions. For instance, a self-determinative document containing sensitive company data can restrict access to authorized users only, even if the document is shared externally. If an employee leaves the company, the document can revoke their access in real-time, ensuring that proprietary information remains secure without requiring legal intervention.

In addition, self-determinative documents have one or more of a variety of attributes and advantages that enable them to address the drawbacks of traditional documents. These include dynamic access control, the ability to be a single source of truth, enhanced security and confidentiality, streamlined collaboration and compliance, universal accessibility, integrity and availability, true ownership, empowering ownership transitions, and enabling a universal frictionless system of record. The advantages of self-determinative documents are further improved when operating as part of and in collaboration with a document management hub. These include an improved visual layout frameworks for presenting document search results, advanced search result filtering, automatic and seamless content propagation, and efficient workflow management. These and other features and advantages enable a world that is transformed by self-determinative documents.

Self-determinative documents replace static, policy-based control with dynamic, real-time access management. For example, in the context of an M&A transaction, a self-determinative document containing trade secrets can enforce strict access permissions based on user roles and security clearances. The document can also log all interactions, providing a comprehensive audit trail that ensures compliance with non-disclosure agreements. Unlike traditional systems that rely on the goodwill of parties to comply with contractual obligations, the embedded intelligence within the document autonomously enforces these obligations, reducing the risk of misuse and eliminating the need for costly and uncertain litigation.

Self-determinative documents may provide robust security features, such as encryption, role-based access control, and multi-factor authentication, to protect sensitive information. For instance, in a real estate transaction, a self-determinative document can ensure that only authorized parties, such as the buyer, seller, and their respective attorneys, can access specific sections of the document. The document can also enforce time-limited access, revoking permissions automatically after the transaction is completed. This level of control eliminates the reliance on external safeguards and ensures that confidential information remains protected.

Self-determinative documents may excel in the metrics of integrity and availability due to their built-in intelligent features, setting them apart from traditional PDFs. Confidentiality is ensured through robust access control mechanisms, such as role-based permissions, multi-factor authentication, and encryption, which prevent unauthorized users from viewing or interacting with the document. Integrity is maintained by embedding intelligence within the document, allowing it to autonomously track changes, log interactions, and enforce version control, ensuring that the document remains authentic and tamper-proof throughout its lifecycle. Availability is enhanced by storing a single authoritative version of the document in a secure, centralized location, accessible from anywhere and across various devices. Unlike traditional PDFs, which are static and prone to duplication, self-determinative documents dynamically manage access and interactions, ensuring that they remain secure, reliable, and accessible at all times. This combination of features makes self-determinative documents a superior solution for modern document management challenges.

Self-determinative documents may enable true ownership by embedding intelligence directly within the document, allowing the owner to maintain control over its lifecycle, access, and interactions, independent of the computer or system storing it. Unlike traditional digital documents, which are tied to the device or platform where they are stored and can be easily copied or modified without the owner's consent, self-determinative documents are designed to enforce ownership rights autonomously. The embedded intelligence ensures that the document's owner can define and enforce access permissions, revoke or grant access in real-time, and track all interactions with the document, regardless of where it is stored or accessed. This capability eliminates the reliance on external systems or legal constructs to maintain control, providing a robust framework for secure and reliable document management. By enabling true ownership, self-determinative documents empower individuals and organizations to protect their sensitive information and ensure compliance with policies and agreements, even in complex digital environments.

A self-determinative document can have immutable content, meaning that the core data of the document cannot be altered once it has been finalized or authenticated. This immutability ensures that the document remains in its original, unmodified state, preserving its integrity and trustworthiness throughout its lifecycle. Achieved through cryptographic techniques such as hashing or digital signatures, immutable content creates a unique fingerprint of the document's data, making any unauthorized modifications detectable and invalidating the document's authenticity. Additionally, embedded executable code within the document can autonomously track and prevent unauthorized changes, further reinforcing its immutability.

The advantages of immutable content are numerous and impactful across various industries and applications. Enhanced security and integrity are among the most significant benefits, as immutable content protects sensitive documents—such as contracts, legal agreements, medical records, and financial reports—from tampering or unauthorized edits. Immutable content also preserves provenance and authenticity, ensuring that the document's original state is traceable and verifiable, which is critical for legal proceedings and regulatory compliance. For example, immutable medical records can demonstrate adherence to HIPAA regulations by providing a tamper-proof history of patient data. Fraud prevention is another key advantage, as immutable content eliminates the risk of altering critical information, such as payment details in invoices, safeguarding both parties in financial transactions. Furthermore, immutable content simplifies version control by maintaining the original document intact while allowing changes to be appended as metadata or separate layers, ensuring transparency and accountability in collaborative workflows.

In decentralized systems, such as distributed ledger-based environments, immutable content guarantees consistency and trustworthiness across all nodes, making it ideal for applications like smart contracts. Long-term preservation is also enhanced, as immutable content ensures that historical records remain reliable and accessible over time, even as technology evolves. This is particularly valuable for archival purposes, where government records or other historical documents must be preserved in their original state.

Immutable content also facilitates efficient dispute resolution by providing an unaltered reference point for resolving conflicts, such as confirming agreed-upon terms in business negotiations. Additionally, it improves user confidence by assuring the authenticity and reliability of the document, which is especially important in digital transactions. Overall, the immutability of content in self-determinative documents is a cornerstone of their reliability and security, offering enhanced integrity, trust, and compliance across a wide range of applications in legal, financial, healthcare, and government contexts.

A self-determinative document can have immutable machine-readable content, meaning that the core data of the document is encoded in a format that cannot be altered once it has been finalized or authenticated and that the content can be read by a computer. As discussed above, this immutability ensures that the document remains in its original, unmodified state, preserving its integrity and trustworthiness throughout its lifecycle. Machine-readable content refers to data that is structured in a way that can be directly processed by computers, such as JSON, XML, or binary formats, enabling advanced computational interactions and automated workflows. When combined with immutability, this content becomes a powerful tool for ensuring security, traceability, and reliability in digital ecosystems.

The immutability of machine-readable content is achieved through cryptographic techniques such as hashing or digital signatures. Hashing generates a unique fingerprint of the document's data, ensuring that even the smallest unauthorized modification can be detected. Digital signatures, created using public/private key pairs, authenticate the document's origin and verify its integrity. Together, these techniques make unauthorized changes detectable and invalidate the document's authenticity if tampering occurs. Additionally, embedded executable code within the document can autonomously track and prevent unauthorized changes, further reinforcing its immutability. This embedded intelligence ensures that the document can actively monitor its own integrity, providing an additional layer of security.

The advantages of immutable machine-readable content are numerous and impactful across various industries and applications. Immutable machine-readable content also simplifies version control by maintaining the original document intact while allowing changes to be appended as metadata or separate layers. This approach ensures transparency and accountability in collaborative workflows, as all modifications are clearly documented without altering the original content.

In decentralized systems, such as distributed ledger-based environments, immutable machine-readable content guarantees consistency and trustworthiness across all nodes. This makes it ideal for applications like smart contracts, where the integrity of the contract terms must be preserved across a distributed network. Long-term preservation is another key advantage, as immutable content ensures that historical records remain reliable and accessible over time, even as technology evolves. This is particularly valuable for archival purposes, where government records or other historical documents must be preserved in their original state to maintain their authenticity and legal validity.

The machine-readable nature of immutable content further enables advanced computational interactions, such as automated compliance checks, semantic analysis, and AI-driven insights. For instance, a legal document encoded in a machine-readable format can be automatically analyzed to ensure compliance with regulatory requirements, flagging any discrepancies or missing clauses. Similarly, a financial report can be processed by AI systems to generate real-time analytics, providing valuable insights into trends and anomalies. These capabilities are made possible by the structured and immutable nature of the content, which ensures that the data remains consistent and reliable throughout its lifecycle.

Overall, the immutability of machine-readable content in self-determinative documents can be a cornerstone of their reliability and security. It offers enhanced integrity, trust, and compliance across a wide range of applications in legal, financial, healthcare, and government contexts. By combining the benefits of immutability with the computational power of machine-readable formats, these documents redefine the standards for security, transparency, and efficiency in digital ecosystems, paving the way for a future where information is universally trustworthy and accessible.

Self-determinative documents enable stateful AI by embedding intelligence directly within the document, allowing it to maintain context, identity, and a persistent record of its interactions. Unlike prior AI solutions, which often rely on fragmented or static data sources, self-determinative documents provide a unified, dynamic, and machine-readable structure that preserves the document's lifecycle, metadata, and relationships with other entities. This persistent state allows AI systems to achieve a higher level of inference, as they can access not only the document's content but also its history, provenance, and contextual relevance. For example, a self-determinative document can record every interaction it has undergone, such as edits, approvals, or access attempts, and make this information available to AI systems for analysis. This enables the AI to infer patterns, predict outcomes, and provide insights that are far more nuanced and accurate than those derived from static or disconnected data.

In contrast, prior AI solutions often operate on isolated datasets or snapshots of information, limiting their ability to understand the broader context or draw deep conclusions. These systems typically require extensive preprocessing to integrate disparate data sources, and even then, they may lack the ability to track changes or maintain continuity over time. For instance, an AI analyzing a traditional contract might only have access to the text of the document, without any knowledge of its revision history, associated workflows, or related agreements. This lack of statefulness restricts the AI's ability to make informed decisions or provide meaningful recommendations.

Self-determinative documents can overcome these limitations by serving as active participants in the AI ecosystem. Their embedded intelligence ensures that all relevant data—whether it pertains to the document's content, metadata, or interactions—is readily accessible and consistently updated. This enables AI systems to perform advanced reasoning, such as identifying dependencies between documents, detecting anomalies in workflows, or simulating counterfactual scenarios. For example, an AI analyzing a portfolio of contracts can use the stateful nature of self-determinative documents to understand how changes in one agreement might impact others, predict compliance risks, or recommend optimizations.

The ability to maintain state also enhances the AI's capacity for personalization and contextual adaptation. By understanding the document's history and the roles of its users, the AI can tailor its responses and actions to the specific needs of each stakeholder. For instance, in a collaborative environment, the AI can prioritize tasks based on the document's workflow history or provide targeted recommendations based on the user's previous interactions. This level of inference is unattainable with prior AI solutions that lack access to a persistent and unified data structure.

Overall, self-determinative documents transform AI from a reactive tool into a proactive and deeply insightful system. By providing a stateful foundation, these documents enable AI to achieve a higher level of inference, bridging the gap between static data processing and dynamic, context-aware reasoning. This advancement not only enhances the accuracy and relevance of AI-driven insights but also unlocks new possibilities for automation, decision-making, and innovation across industries.

The transition to a world dominated by self-determinative documents marks a significant shift in how individuals and organizations interact with digital information. For example, the reliance on paper documents diminishes significantly in a self-determinative document world. Traditional paper-based workflows, such as printing, signing, and scanning, are replaced by digital processes that leverage embedded intelligence and biometric authentication. For instance, contracts and agreements can be signed electronically using facial recognition or fingerprint scans, eliminating the need for physical signatures. Self-determinative documents can autonomously verify the authenticity of these biometric inputs, ensuring that the signing process is secure and tamper-proof. This reduction in paper usage not only streamlines workflows but also contributes to environmental sustainability by minimizing waste and resource consumption.

One of the most noticeable changes may be the reduction in the use of traditional input methods, such as keyboards. Self-determinative documents, equipped with embedded intelligence and dynamic interfaces, allow users to interact with documents through voice commands, gestures, and AI-driven prompts. For example, instead of typing lengthy edits or comments, users can verbally instruct the document to make changes, with the embedded intelligence processing and executing these commands in real-time. This shift not only enhances efficiency but also makes document interaction more intuitive and accessible, particularly for individuals with physical limitations or those working in environments where traditional input devices are impractical.

As self-determinative documents become the standard, traditional signatures may increasingly be replaced by AI-driven and biometric interactions. Embedded intelligence within the document can analyze and authenticate biometric data, such as voice patterns, facial features, or fingerprints, to confirm user identity and authorize actions. AI further enhances this process by providing contextual insights and recommendations, such as suggesting edits, highlighting discrepancies, or automating repetitive tasks. For example, a self-determinative document used in a legal setting can flag clauses that require attention or suggest alternative language based on prior agreements. These advancements reduce reliance on manual processes and foster a more seamless and secure interaction with digital documents, paving the way for a future where document management is driven by intelligence and innovation.

In a post-PDF world dominated by self-determinative documents, the advantages extend to improving operational efficiency and reducing human error. For example, in industries such as healthcare, self-determinative documents can autonomously update patient records based on real-time inputs from medical devices or lab results. This eliminates the need for manual data entry, reducing errors and ensuring that healthcare providers have access to the most accurate and up-to-date information. Similarly, in logistics, self-determinative shipping manifests can dynamically adjust based on inventory changes or delivery schedules, streamlining operations and minimizing delays.

Another advantage is the ability to enforce granular access control and compliance across diverse environments. For instance, in financial services, self-determinative documents can restrict access to sensitive sections of a report based on user roles, such as allowing auditors to view transaction details while limiting access for junior staff. The embedded intelligence within the document ensures that compliance with regulatory requirements, such as GDPR or HIPAA, is maintained without the need for constant oversight. This capability is particularly valuable in industries where data security and privacy are critical.

Self-determinative documents also enhance collaboration by enabling real-time interaction among multiple users. For example, during the drafting of a legal contract, stakeholders can simultaneously edit and comment on the document, with changes tracked and logged by the embedded intelligence. This eliminates the need for back-and-forth email exchanges and ensures that all parties are working on the same version of the document. Additionally, the document can provide insights into the collaboration process, such as identifying sections that require further discussion or highlighting areas of agreement.

The ability to integrate with artificial intelligence (AI) systems further amplifies the advantages of self-determinative documents. For example, in marketing, AI-driven self-determinative documents can analyze user engagement data to suggest improvements to campaign strategies. A marketing report might highlight trends in customer behavior or recommend adjustments to ad placements based on real-time analytics. In education, self-determinative documents can adapt their content based on student performance, providing personalized learning experiences that cater to individual needs.

Another transformative advantage is the ability to create tiered access systems that align with business models. For instance, a subscription-based service can use self-determinative documents to offer different levels of access to content based on subscription tiers. A basic subscriber may access summary reports, while premium subscribers can view detailed analytics and proprietary insights. This flexibility allows businesses to monetize their content effectively while maintaining control over its distribution.

Finally, self-determinative documents may contribute to building trust and transparency in digital interactions. By maintaining a single authoritative version and providing detailed audit trails, these documents ensure that all interactions are traceable and verifiable. For example, in supply chain management, self-determinative documents can track the provenance of goods, ensuring that stakeholders have confidence in the authenticity and quality of products. This capability is particularly valuable in industries such as pharmaceuticals or luxury goods, where trust and transparency are paramount.

In summary, the post-transition world of self-determinative documents offers a wide range of advantages, from operational efficiency and enhanced collaboration to improved security, personalization, and environmental sustainability. By leveraging embedded intelligence and dynamic capabilities, these documents transform the way individuals and organizations manage, interact with, and derive value from digital information.

The following detailed description provides an in-depth explanation of the systems, methods, and interfaces for modifying digital content in documents and gathering information about documents by communicating directly with these documents. Further, these documents are smart documents with embedded intelligence that enables them to manage and track their lifecycle, interactions, and security. This disclosure enumerates how self-determinative documents and a document management hub facilitate the simultaneous modification of various parts of electronic documents via editing data (e.g., metadata) that are linked directly to sole authoritative versions of these documents. Further, by leveraging advanced features such as in-document applications—software applications embedded as part of and which reside within the environments of these documents—users can communicate with other documents directly from a particular document and gather a wide variety of data about these documents, e.g., amount of time a user spent reviewing a particular part of these documents, the number of users that may have reviewed these documents over a time interval, the type of changes made to these documents, and so forth. The embodiments described herein are intended to be illustrative and not restrictive, allowing for modifications and enhancements to meet evolving needs.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

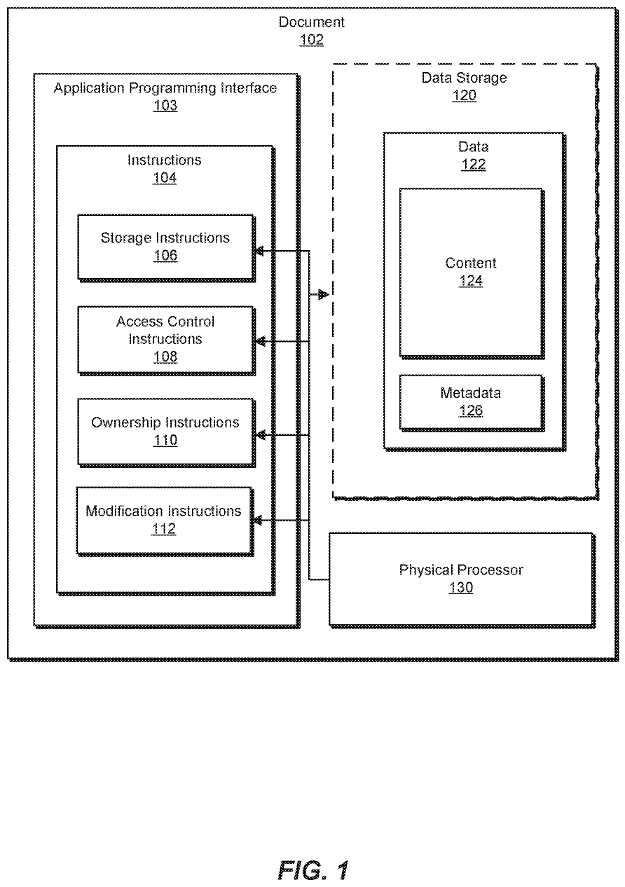

FIG. 1 depicts a structure of a self-determinative document. The self-determinative document 102 (interchangeably referenced in this disclosure as the electronic document 102 or the document 102) serves as digital infrastructure that integrates various interfaces and components to manage various aspects of the document, e.g., access to the document, editing the document, sharing the document, and so forth. Provisioned as digital infrastructure, the document 102 includes an application programming interface (API) 103 (referred to herein interchangeably as “API,” “application programming interface,” API 103) with instructions 104. The instructions 104 play an important role in the operation of the electronic document 102, namely providing the necessary connections between the document 102 and its various functionalities. These instructions 104 include the storage instructions 106, access control instructions 108, ownership instructions 110, and modification instructions 112. Each set of instructions is responsible for a specific aspect of the document's functionality, ensuring that data is stored securely, access is controlled, ownership is maintained, and modification of content in electronic documents (e.g., via execution of the modification instructions 112) is managed.

The storage instructions 106 are responsible for managing the storage of data within the document 102. The storage instructions 106 interact with the data storage 120 to ensure that data 122 is stored efficiently and securely. The storage instructions 106 facilitate the retrieval and updating of data 122, allowing the document 102 to maintain a single true copy and ensuring consistency across all accessed versions. These storage instructions 106 play an important role in the document's ability to provide dynamic content rendering and real-time updates.

The access control instructions 108 manage who can access the data within the document 102. These instructions determine whether an entity is allowed to access the document 102 and control access based on predefined rules and permissions. By ensuring that only authorized users can interact with the document 102, the access control instructions 108, when executed, provide a secure environment for document management. The access control instructions 108 are essential for the document's capability to enable secure sharing and collaboration among multiple users with varying access levels. Further these instructions, when executed, ensure that multiple authorized users may simultaneously access and revise one or more parts of the document 102 such that the revisions appear on respective users interfaces of various devices associated with these users.

The ownership instructions 110 are designed to maintain control over the document 102, even when shared with third parties. This interface enables the document's owner to manage ownership rights and control the distribution of the document 102. This feature is important for ensuring that the document's ownership is preserved and that the document 102 can be linked to a specific context in which the document 102 was shared. The ownership instructions 110 provide the document's owner with the ability to revoke access or grant temporary access as needed.

The modification instructions 112 are responsible for facilitating modification of content within the document 102 such as the inclusion or deletion of text, images, video files, audio files, and a variety of other types of content. The modification instructions 112 can be accessed via a number of other devices different from the memory of the device in which the single authoritative version of the document 102 is stored. For example, the electronic document 102, via execution of the modification instructions 112, independently or in combination with one or more of the storage instructions 106, access control instructions 108, and ownership instructions 110, facilitates modification of contents of the document 102 from each of these different devices, approximately in real time (e.g., within a few seconds or fractions of a second).

The data storage 120 supports the document 102, offering a secure location for storing data 122. The data storage 120 operates in conjunction with the storage instructions 106 to ensure that data is stored in an efficient and secure manner. The design of the data storage 120 maintains a single true copy of the document 102, ensuring consistency across all accessed versions. Data storage for self-determinative documents can be implemented in various configurations, including a single cloud-based server, distributed across multiple servers or devices, or within an on-premises system, each offering distinct advantages based on scalability, security, accessibility, and compliance needs. In a single cloud-based server setup, the data storage is hosted on centralized platforms like Amazon Web Services (AWS) or Microsoft Azure, ensuring that the document and its associated data are stored securely and accessible globally.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

The physical processor 130 is a hardware component that executes the instructions 104 embedded within the document 102. The physical processor 130 enables the document 102 to perform functions such as detecting signing actions, recording signatures, and managing the lifecycle of the document. This integration of hardware and software allows the document 102 to operate independently, adapting to various user environments and workflows.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provide transparency to users by enabling them to verify the authenticity and integrity of the content at any time. This transparency is achieved through audit trails and visual indicators, ensuring that users can trust the document's reliability and security.

This configuration is useful for organizations prioritizing scalability and disaster recovery, as it allows employees across regions to access the most up-to-date version of the document without duplicating or fragmenting the data. The data storage 120 refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

Alternatively, a distributed storage model spans multiple servers or devices, creating a decentralized system that ensures redundancy, fault tolerance, and localized access. For example, financial institutions may store documents across geographically dispersed servers to minimize latency and ensure high availability, often leveraging technologies like blockchain to maintain tamper-proof authenticity and traceability. On-premises systems, where data storage is hosted entirely within an organization's local infrastructure, can provide maximum control and security, making them ideal for handling sensitive or regulated data, such as patient medical records or classified government documents. This setup ensures compliance with privacy regulations and eliminates reliance on external internet connectivity, allowing uninterrupted access even in environments with limited network availability.

A hybrid storage model combines cloud-based and on-premises systems, enabling organizations to store sensitive data locally while leveraging cloud platforms for less critical data or global access. For instance, a government agency might store classified documents on-premises while using cloud storage for public-facing reports, balancing scalability with compliance. Regardless of the configuration, the design of the data storage ensures that the document maintains a single true copy, preventing duplication or fragmentation of data. Synchronization protocols, cryptographic techniques, and metadata tracking ensure consistency across all accessed versions, while security measures like encryption and access controls protect the data from unauthorized access or tampering. By leveraging these flexible storage options, organizations can confidently manage their self-determinative documents in a manner that aligns with their operational, security, and compliance requirements.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The data 122 stored within the data storage 120 represents the content of the document 102. The data 122 is managed by the storage instructions 106 and is subject to the access control instructions 108, ownership instructions 110, and modification instructions 112. The data 122 serves as a central component of the document's functionality, providing the information that users and other entities interact with and manage through the document's application programming interface 103.

The data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

### Process Metadata

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Consider a scenario involving a contract document. The process metadata for this document might include a log of when the contract was drafted, when it was sent to a client for review, and when it was signed by both parties. It might also record any amendments made to the contract, along with the identities of the individuals who made those changes. This metadata provides a transparent and unambiguous record of the document's lifecycle, which is invaluable for compliance, auditing, and dispute resolution.

Another example is a receipt document. The process metadata for a receipt might include information about when the receipt was issued, when it was submitted for reimbursement, and when it was approved by the finance department. This metadata ensures that the document's history is traceable and verifiable, reducing the risk of errors or fraud.

### Semantic Metadata

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

An example provided in the discussion involves an NDA document. The semantic metadata for this document might include fields specifying the parties involved, the date the agreement was signed, and the expiration date of the confidentiality obligations. This metadata not only categorizes the document but also enriches it with contextual information that is directly related to its purpose and use.

### Content-Related Metadata

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

For example, a marketing presentation might include content-related metadata that identifies the title slide, the key points in each section, and the images used to illustrate the presentation. This metadata allows the document to be rendered dynamically based on the user's device or context. On a mobile phone, the presentation might be displayed as a series of concise bullet points, while on a desktop, it might be shown in its full layout with detailed graphics.

Another example is a financial report. The content-related metadata for this document might include tags for each section, such as “Executive Summary,” “Revenue Analysis,” and “Expense Breakdown.” These tags enable users to navigate the document efficiently and allow the system to extract specific sections for use in other workflows or applications.

### Bidirectional Relationship Between Metadata and Document

One aspect of metadata in documents that are digital infrastructure is its bidirectional relationship with the document itself. Changes to the metadata can directly modify the document, and updates to the document can automatically update the metadata. This dynamic interaction ensures that the document and its metadata remain consistent and synchronized.

For example, if the due date for a receipt is updated in the metadata, the document itself might display a notification or highlight the updated due date. Conversely, if a user adds a comment to a document, the metadata might be updated to include information about the comment, such as the timestamp and the identity of the commenter. This bidirectional relationship enhances the document's utility and ensures that all changes are accurately reflected across its metadata and content.

### Examples of Metadata in Action

The discussion provided several compelling examples of how metadata can be used to enrich and enhance documents:

Dynamic Forms: Metadata can specify fields that need to be filled within a document, such as names, dates, and signatures. For example, an NDA document might include metadata fields for the names of the parties involved and the date of signing. These fields can be dynamically updated based on user input, ensuring that the document remains accurate and complete.

Action Logs: Metadata can record actions that need to be performed with a document, such as submitting it for approval or attaching supporting documents. For instance, a receipt might include metadata specifying that it needs to be submitted to the finance department by a certain date.

Queryable Data: Metadata enables documents to be fully queryable, allowing users to retrieve information efficiently. For example, a user might query the system to find all receipts above $10 or all contracts signed in the last year. This capability transforms documents into active, searchable entities.

Multi-Document Data Layer: Metadata from multiple documents can be aggregated into a centralized database, enabling cross-document queries and analysis. For example, an enterprise might use this data layer to analyze spending patterns across all receipts or identify trends in contract negotiations.

Metadata can be the backbone of smart documents, providing the structure and intelligence needed to transform them from static files into dynamic, interactive entities. By capturing process history, semantic characteristics, and content structure, metadata enables advanced computational interactions, efficient organization, and seamless workflows. The examples provided illustrate the versatility and power of metadata, highlighting its role in creating a new paradigm for digital documents.

The physical processor 130 is responsible for executing the instructions necessary for the operation of the document 102. The physical processor 130 handles updates to the document 102 and ensures that the document's functionalities are carried out efficiently. The physical processor 130 works in conjunction with the API 103 to execute the document's operations and manage the interactions of the document 102 with users and external systems. In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the components described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The API 103 provides a standardized interface for interaction between the document 102 and external systems or users. The API 103 enables a range of functionalities, including controlled access, modification, and management of the content of the document. It serves as a conduit for interaction, allowing the document 102 to integrate seamlessly with other software systems and support enhanced functionalities like automated workflows and data synchronization. The integration of API 103 transforms the document 102 into an active, controllable entity that can interact with its environment in a secure and managed manner.

In the context of embodiments of this disclosure, the API embedded within the document serves as a pivotal component that transforms the document into a smart digital object. This API is not merely a set of protocols for building and interacting with software applications; it is an integral part of the document itself, enabling a wide array of functionalities that enhance the document's utility, security, and control.

The API 103 provides a standardized interface that enables the document to interact seamlessly with external systems, applications, and users. This integration enables the document to function as part of a larger digital ecosystem, where it can communicate and exchange data with other software systems, such as cloud services, enterprise applications, and third-party tools. Through the API 103, the document's owner or controller can remotely manage the document's access and usage. This includes monitoring who accesses the document, tracking changes, and enforcing security protocols. The API allows for real-time updates and modifications, ensuring that the document remains current and relevant, regardless of its location or the number of copies in existence.

The API can be equipped with robust security features, such as encryption and access control mechanisms, to protect the document from unauthorized access and tampering. It acts as a gatekeeper, ensuring that only authorized users can interact with the document. This level of security is essential for maintaining the integrity and confidentiality of the document's content. Additionally, the API enables dynamic content rendering, allowing the document to display the most current information and adapt its content based on user interactions or external data inputs. This capability is particularly useful for documents that require real-time updates, such as financial reports, legal documents, or collaborative projects.

By embedding the API within the document, embodiments of this disclosure support enhanced functionalities like automated workflows, data synchronization, and collaborative features. The API allows the document to function as an interactive and responsive entity that can interact with and respond to its environment, users, and other systems in a secure and managed manner. Furthermore, the API ensures that the document is device and platform agnostic, meaning it can be accessed and interacted with from various types of devices and operating systems without compatibility issues. This flexibility helps ensure that the document can be used effectively in diverse digital environments.

In some examples, the API serves as an immutable interface, providing a consistent and reliable framework for accessing and interacting with the document. This immutability ensures that the document's structure and access protocols remain stable over time, enhancing trust and reliability for users and applications interacting with the document. In summary, the API embedded within the document is a transformative component that elevates the document from a static file to a dynamic, interactive digital object. It provides the necessary infrastructure for secure, controlled, and flexible document management, addressing the challenges of traditional document handling and offering a comprehensive solution for modern digital environments. In other examples, some aspects of the API may be updated or revised over time without impacting accessibility of the document or the immutability of the content of the document.

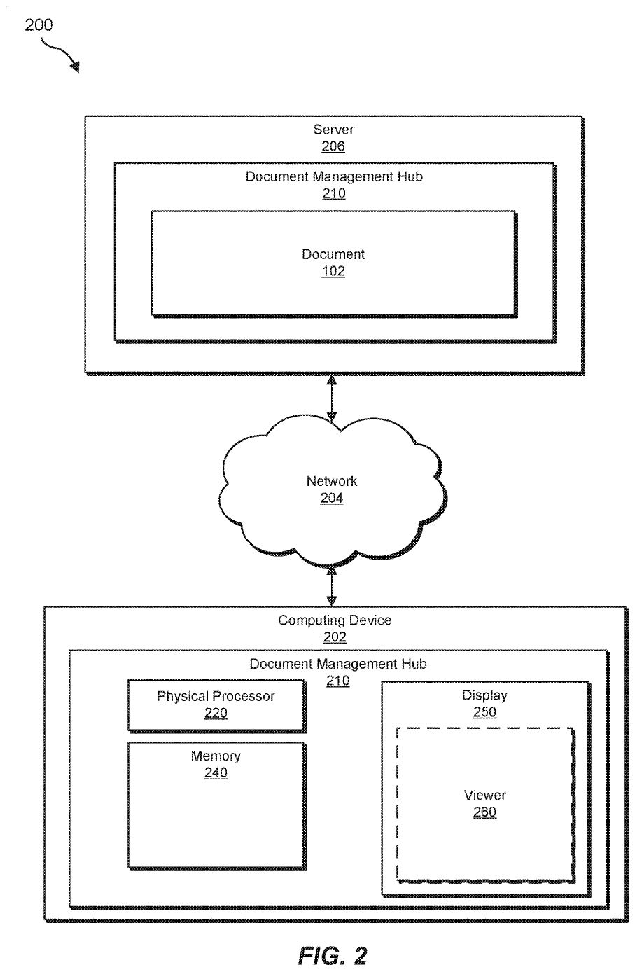

FIG. 2 can represent an architecture for managing electronic documents as smart digital objects. The system 200 comprises a computing device 202, a network 204, a server 206, a document 102, a document management hub 210 that can operate simultaneously in the server 206 and the computing device 202, a physical processor 220, a memory 240, and a viewer 260 that may be output on a display 250 communicatively coupled to the computing device 202.

The computing device 202 is a user-operated device that facilitates interaction with the system 200. The computing device 202 is operatively connected to the network 204 and includes the physical processor 220, the memory 240, and the viewer 260. The computing device 202 may be implemented as various types of devices, such as a mobile phone, tablet, desktop computing device, or laptop computing device. The physical processor 220 within the computing device 202 executes instructions to perform operations related to accessing and managing the document 102. The memory 240 stores data and instructions necessary for the operation of the computing device 202, including temporary and permanent storage of document-related information. The viewer 260 is responsible for rendering the content of the document 102 for presentation to the user, enabling functionalities such as real-time updates and collaborative editing.

The network 204 provides the communication pathway between the computing device 202 and the server 206. This pathway enables the transmission of requests, responses, and document content, while maintaining secure and efficient data exchange. The network 204 may be implemented using various communication technologies, including wired and wireless connections, and supports protocols such as TCP/IP and HTTP. The server 206 is a remote computing system that hosts the document 102. The server 206 is connected to the network 204 and interacts with the computing device 202 to process access requests and deliver the content of the document 102. The document 102 stored on the server 206 operates as a self-governing smart document capable of enforcing access permissions, tracking changes, and preserving the fidelity of the content within the document.

The document management hub 210 can comprise of one or more machine readable instructions that are capable of being accessed and executed simultaneously by the processors of multiple devices, e.g., the computing device 202 and the server 206. While all of the machine readable instructions that comprise the document management hub 210 may be executable on multiple devices, not all devices may have access to all of the instructions that comprise the document management hub 210. The document management hub 210 comprises a set of instructions that control the generation and display of information. Further, the document management hub 210, in part, facilitates communication and sharing of information (1) between the electronic document 102 and instances of the electronic document 102 (e.g., cover pages), and (2) from one cover page to one or multiple cover pages.

The physical processor 220 within the computing device 202 executes operations related to the system 200, including processing access requests, rendering document content, and managing user interactions. This component facilitates the computing device 202 in performing tasks independently and with optimized performance. The memory 240 provides storage capabilities for the computing device 202, including the temporary caching of document data and the storage of instructions required for the operation of the viewer 260. This configuration enables the computing device 202 to access and manage the document 102 in an efficient manner.

The viewer 260 serves as the interface enabling the user to engage with the document 102. This component presents the content of the document 102 for display, facilitating actions such as viewing, editing, and collaboration. The viewer 260 accommodates real-time updates and maintains alignment between the displayed content and the version stored on the Server 206.

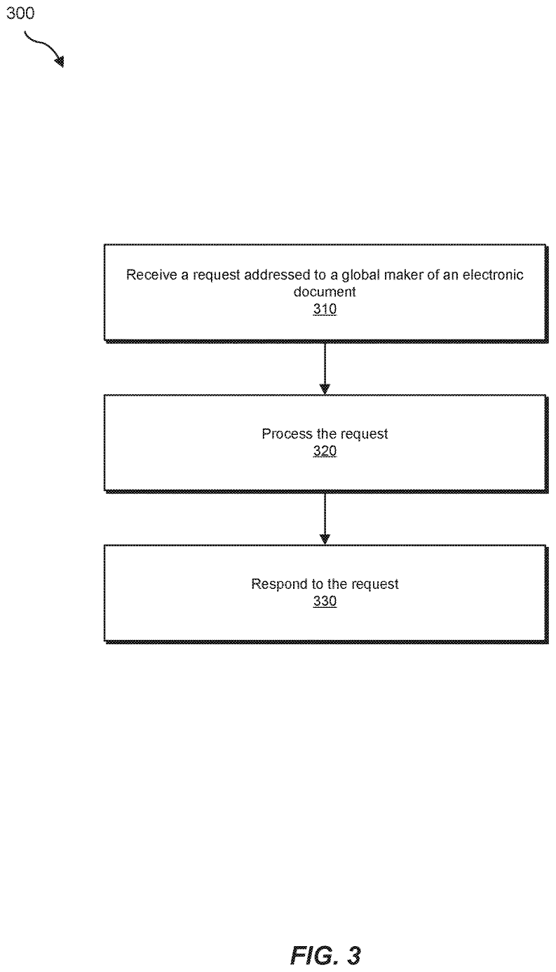

FIG. 3 illustrates a flowchart 300 of a method for responding to a request addressed to an electronic document 102. The electronic document will be referenced in this disclosure as “the electronic document 102” or “the document 102,” or as “the electronic document,” or “the document.” This flowchart begins with step 310, wherein the electronic document 102 receives a request addressed to a global marker of the electronic document. Then, at step 320, the electronic document 102, via execution of the electronic document 102 (e.g., one or more instructions of the instructions 104, processes the request. Finally, the electronic document 102, via execution of the electronic document, responds to the request.

At the outset, it is instructive to briefly revisit the concept of the document 102 as described herein. The document 102 acts as or is provisioned as digital infrastructure that integrates various interfaces and components to manage and update several capabilities and functionalities of the document. Specifically, the document 102 operates as a smart digital object capable of interacting with and incorporating various aspects of other electronic documents, various types of digital content (e.g., embedded videos, images, etc.), and aspects of a filing framework specific to an entity, e.g., government, company, etc. In some aspects, the document 102 operates as digital infrastructure within the document management hub 210 and accesses, interacts with, and performs various actions using code, data, and metadata included as part of the document 102 and code, data, and metadata included in other electronic documents.

The document 102 performs these actions either independent of or while operating in combination with the document management hub 210. Further, the document 102 provisioned as digital infrastructure can include three layers of data, namely code, data, and metadata. Each of the code, data, and metadata are simultaneously, sequentially, or in some other way accessible and executable by (1) the document 102 itself, (2) other documents provisioned as digital infrastructure and authorized to access the document 102, and (3) the document management hub 210.

Code, as described herein, refers to instructions written in a programming language (Java, C++, Python, etc.) that can be executed by, e.g., the server 206, the computing device 202, or another device that accesses the electronic document 102. When executed, the code facilitates (1) the performing of computations specific to the document 102, (2) access to the electronic document 102 by other devices, (3) revising of the electronic document 102, and (4) setting and updating of restrictions specific to the document 102. The code can be included as part of any of the set of instructions described above and shown in FIG. 1.

The data relates to the enhancing of the functionality, accessibility, and/or security of the document 102. This data can be stored directly within the document as embedded metadata, semantic tags, or encrypted content. This data and/or metadata associated with an electronic document may be stored in a single device or multiple devices. The data can refer to raw values or content that is processed by the code described above. Alternatively or additionally, data can be accessible by the document 102 through various sources, such as linked databases or cloud storage systems, etc. The document 102 can dynamically retrieve and update information in real-time from various sources, e.g., financial reports, investment prospectuses, stock prices or various user interactions. Moreover, as stated above, electronic documents provisioned as digital infrastructure can implement a number of access restrictions on themselves according to the preferences of the document owners. These restrictions can be updated approximately in real time as per the preferences of the document owners.

Additionally, data can be associated with the document 102 in other suitable ways, such as through audit trails, access logs, or related documents stored in a centralized system (e.g., the document management hub 210), providing a comprehensive view of the document's history and interactions. In some aspects, the APIs included as part of these documents provides a comprehensive view of a document interaction history to the owners. Indeed, in some examples, the term “electronic document” refers to any data, metadata, audit information, or intelligence that pertain to the electronic document. In other words, an electronic document may be made up of its data, metadata, intelligence, and/or other information. The data, metadata, intelligence, and/or other information of a document may be stored in any suitable manner (e.g., each of these items may be stored in a single database or device, distributed across multiple database or devices, distributed across networked devices, etc.).

Data may be stored within or otherwise associated with an electronic document through execution of the electronic document on a computing device, a process that enables the document's function as a smart digital object. In some aspects, this process is not merely about saving data in a conventional sense but involves a sophisticated mechanism that ensures the document acts as a dynamic and interactive entity. As explained above, in some examples, the document is provisioned to maintain a single true copy, which facilitates ensuring consistency and integrity across all accessed versions. This single true copy can be stored in a secure environment, leveraging cloud-based infrastructure to facilitate accessibility and scalability.

Storing data within a document through execution of the document refers to the process where the document itself, as an active digital entity, manages and updates its own data content dynamically. This concept transforms the document from a static file into an interactive and intelligent object capable of executing various types of code. In some examples this involves including executable code or an API as part of the document, which allows it to perform actions such as data retrieval, processing, and storage autonomously.

For example, a document could be programmed to fetch the latest data from a remote server or database whenever it is opened, updating its content with real-time information such as current stock prices or weather forecasts.

Finally, metadata refers to the underlying information descriptive of the data. For example, the metadata can be characteristics, context, or structure of the data such that if the data corresponds to an image file, the metadata can be the dimensions, resolution, date information of the image file, and so forth. In another example, if the data were a video, the metadata may correspond to the duration of video, the video file size, etc. The code, data, and metadata are interoperable such that any or all of the code, data, or metadata of an electronic document 102 can be accessed and/or executed by the electronic document 102, the document management hub 210, or other documents provisioned as digital infrastructure.

Returning to FIG. 3, step 310 involves receiving a request addressed to a global marker of the electronic document 102. The request is associated with, e.g., opening the electronic document 102 in order to access digital content (e.g., video files, audio files) embedded therein, modify digital content of the document (e.g., add or remove text), and so forth. Various entities may initiate such requests, e.g., employees, contractors, or collaborators, who need to access the document for work-related purposes. They may request access to view, edit, or comment on the document based on their roles and permissions. Automated systems, such as software applications or services, may also require access to the document for processing or integration purposes. For example, a data analysis tool can request access to extract information from the document for reporting or analytics. External partners, including business partners, clients, or vendors, may need access to the document as part of a collaborative project or transaction, with limited or conditional access based on agreements or contracts.

Regulatory bodies, such as government agencies or compliance auditors, can request access to the document for verification or auditing purposes, typically governed by legal or regulatory requirements. Third-party applications that integrate with the document's API to provide additional functionality, such as document signing, workflow automation, or content management, may request access to perform specific tasks or operations. Additionally, cloud services that host or manage the document as part of a broader digital ecosystem may request access to synchronize data, perform backups, or facilitate collaboration across different users and devices. Each of these entities may have different levels of access and permissions, which are managed and controlled through the document 102 to ensure security and compliance with organizational policies.

Additionally, the document's API 103 (or other instructions of the document 102) can support role-based access control, allowing different levels of access based on the entity's permissions. This means that the document can provide personalized access experiences, where users with different roles or security clearances see only the parts of the document they are authorized to view. This capability is particularly important in environments where sensitive information must be protected from unauthorized access. The document can also maintain a real-time access control list, dynamically updated based on user activity and permissions. This list ensures that access decisions are made with the most current information, enhancing the document's security and control capabilities.

Returning to step 310, in some aspects, the global marker can be an identifier specific to the electronic document 102 such as a uniform resource identifier (URI), a uniform resource locator (URL), universally unique identifier (UUID), or a globally unique identifier (GUID). The electronic document 102 does not share this global marker with any other document provisioned as infrastructure, and as such, this global marker serves as a unique identification mechanism of the document 102. In aspects, the global marker can be a hexadecimal character-based address that is associated with and specific to electronic document 102. Additional details about the global marker are described later on in this disclosure.

Step 320 involves the electronic document 102, via execution of the document 102, processing the request. Via execution of one or more of the instructions 104 of the electronic document or via execution of one or more instructions accessed by the document management hub 210 and the execution of one or more of the instructions 104, the electronic document 102 analyzes the request. For example, the electronic document 102 determines the nature of the request, the device or entity initiating the request, the metes and bounds of the request, and so forth. The electronic document 102 can determine that the request was received from a device associated with a user authorized to access the document 102 and that this user can access all or only some parts of the document 102.

Step 330 involves the electronic document 102 responding, via execution of one or more of the instructions 104 of the electronic document or via execution of one or more instructions accessed by the document management hub 210 and the execution of one or more of the instructions 104, to the request. For example, the electronic document 102 can respond to the request by facilitating access to the document 102, and enabling one or more authorized users to (1) modify contents of the document 102, (2) revise access restrictions and preferences associated with the document 102, and (3) permit outputting of modified content of the electronic document 102 simultaneously on multiple displays coupled to the devices of multiple authorized users.

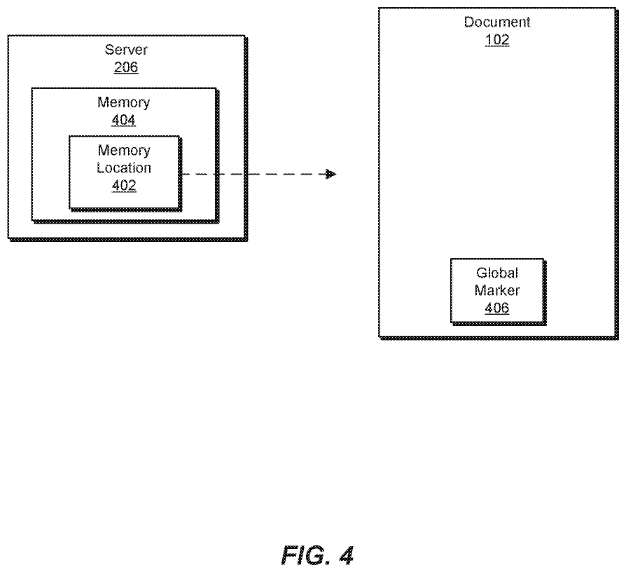

FIG. 4 illustrates the electronic document 102 as stored in a nonshared globally addressable location in memory of a device. Specifically, the electronic document 102—the sole authoritative version of the document 102—is stored in a unique and globally addressable location, e.g., in memory location 402 of memory 404 of the server 206. The memory location 402 is linked to the global marker 406 embedded in the electronic document 102—a hexadecimal character based address (e.g., 019566cf-618e-7832-8332-9b7b14d16034)—and is accessible by various authorized users via their respective devices. As stated, the global marker 406 can be a Uniform Resource Locator (URL), Universally Unique Identifier (UUID), or a Globally Unique Identifier (GUID), or a set of alphanumeric characters based on some permutation or combination of one or more of these identifiers.

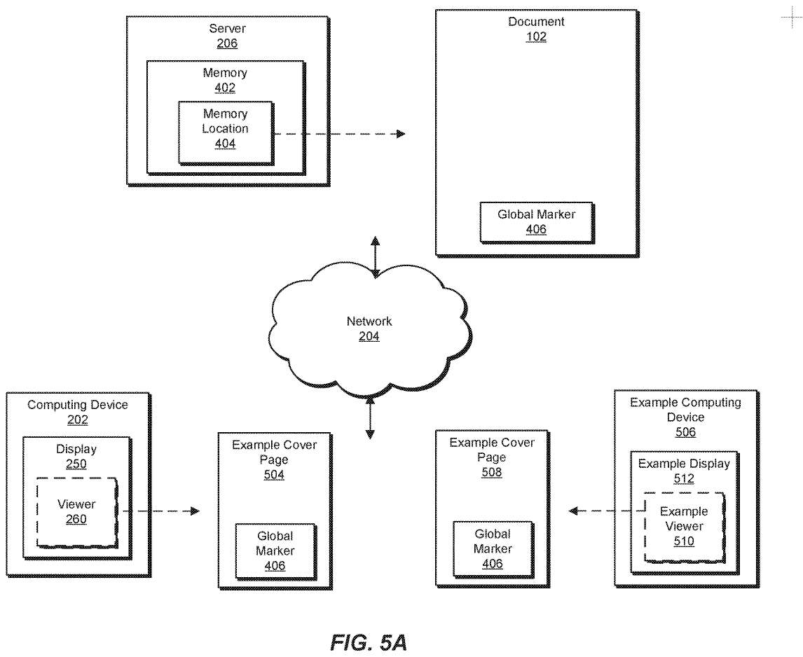

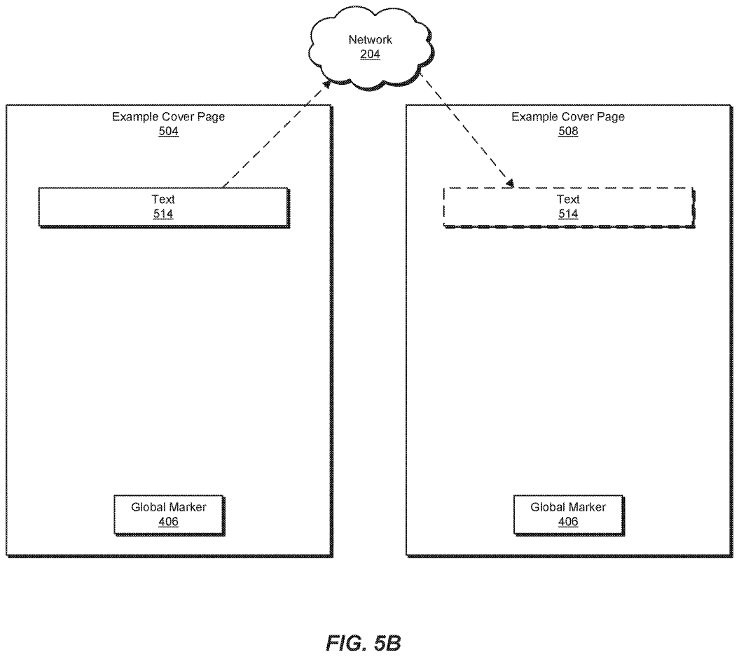

FIG. 5A illustrates the electronic document 102 being accessed simultaneously from multiple devices. For example, a user can select a user selectable link representative of the electronic document 102 output on the viewer 260 (a user interface) of the display 250 communicatively coupled to the computing device 202 (e.g., the user's device). Upon selection, the document management hub 210, via executing one or more of the instructions 104 and/or various additional instructions, facilitates the outputting of an example cover page 504 on the display 250. The example cover page 504 includes the global marker 406 embedded within the page and serves as a gateway or portal via which the device 202 accesses the electronic document 102, the sole authoritative version of the document 102.

The example cover page 504 is directly linked to the electronic document 102, and by extension, the memory location 402. When a user modifies digital content on the example cover page 504, the electronic document 102 operating independently, via execution of one or more of the instructions 104, or in combination with the document management hub 210 (via execution of additional instructions), implements the digital content modification directly on the electronic document 102, e.g., approximately in real time (within a few seconds or fractions of a second). In other words, the user of the computing device 202 modifies the content of the electronic document 102 using the example cover page 504 as gateway or portal.

Likewise, another user associated with a computing device (e.g., example computing device 506) different from the computing device 202 and the server 206 can interact with an example cover page 508 that also includes the global marker 406 embedded there. Just as in the example cover page 504, the example cover page 508, output on example viewer 510 of example display 512, serves as an instance of the electronic document 102 and is directly linked to the electronic document 102. When the user of the example computing device 506 modifies any content on the example cover page 508, the electronic document 102 implements, approximately in real time, the content modification on the electronic document 102 as described above. In this way, the example cover pages 504 and 508 serve as gateways to the single authoritative version of the document—the electronic document 102. The electronic document 102 is communicatively coupled to the example cover pages 504 and 508 via the network 204.

FIG. 5B illustrates the near simultaneous display of content modifications on the example cover page 504 and the example cover page 508. For example, the example cover page 504 linked to the electronic document 102 can be a contract for the purchase of real property. In this scenario, the user—one that is authorized to access the electronic document 102—may enter text on part of the example cover page 504. In response, the document 102, linked to example cover page 504, executes at least the modification instructions 112 to propagate changes made to the cover page 504 onto the electronic document 102 and any other example cover pages directly linked to the document 102 via, e.g., the global marker 406.

In other words, the electronic document 102 includes the text 514, approximately in real time, on both the electronic document 102 and the example cover page 508. The dotted lines around the border of the text 514 indicate the approximately real time propagation of the text 514 upon modification of the example cover page 504. Further, as the document 102 is provisioned as digital infrastructure, the document 102 executes one or more of the stored instructions 106, the access control instructions 108, ownership instructions 110, and the modification instructions 112 to generate a timeline of any previous or future changes made to the document 102. For example, the electronic document stores identification details regarding the user that is responsible for the modification, the date and time of the modification, and so forth, within the memory location 402. In this way, the identification details become an immutable part of the document 102.

In some aspects, the electronic document 102 incorporates the text 514 by operating in conjunction with the document management hub 210. For example, the document 102 modifies data of the document via (1) execution of at least the modification instructions 112 and (2) execution, by the document management hub 210, of additional instructions, as a result of which the text is included as part of every example cover page that includes the global marker 406. In aspects, the electronic document 102 analyzes access control instructions 108 to determine whether a particular example cover page associated with a user is authorized to include the modification.

For example, the text 514 can correspond to confidential information associated with a buyer, e.g., address, salary, loan approval status, and so forth. In this scenario, the electronic document 102 identifies example cover pages associated with users with whom sharing the confidential information is permitted by law and advisable, e.g., loan officers, closing attorneys, and so forth. In other words, the built-in intelligence of the electronic document 102 analyzes both the subject matter of the text and the appropriateness of propagation of the text prior to completing the propagation of the modification.

It is noted that additional changes to data may be made on the example cover page 508. For example, the user of the example computing device 506 may be interacting with the example cover page 508 output on the example viewer 510 and could, e.g., include an image or embed a video as part of the example document cover page 508. Just as the example cover page 504 propagated the text 514, the example cover page 508 may propagate the image or embedded video, approximately in real time, as part of the example cover page 504 and the electronic document 102.

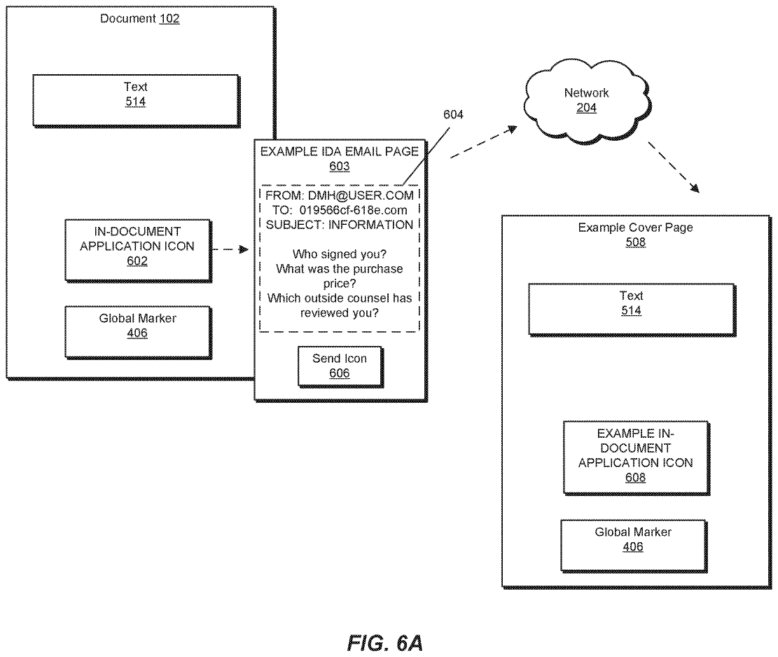

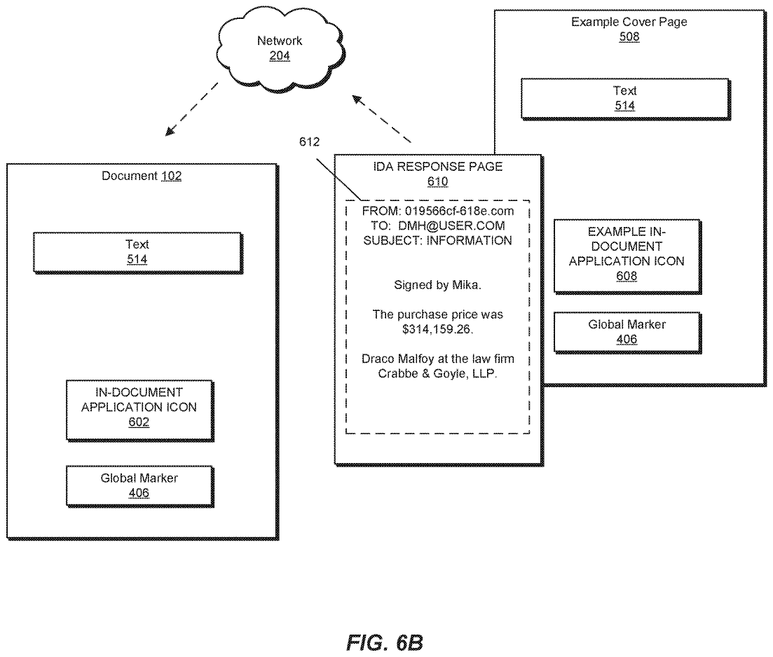

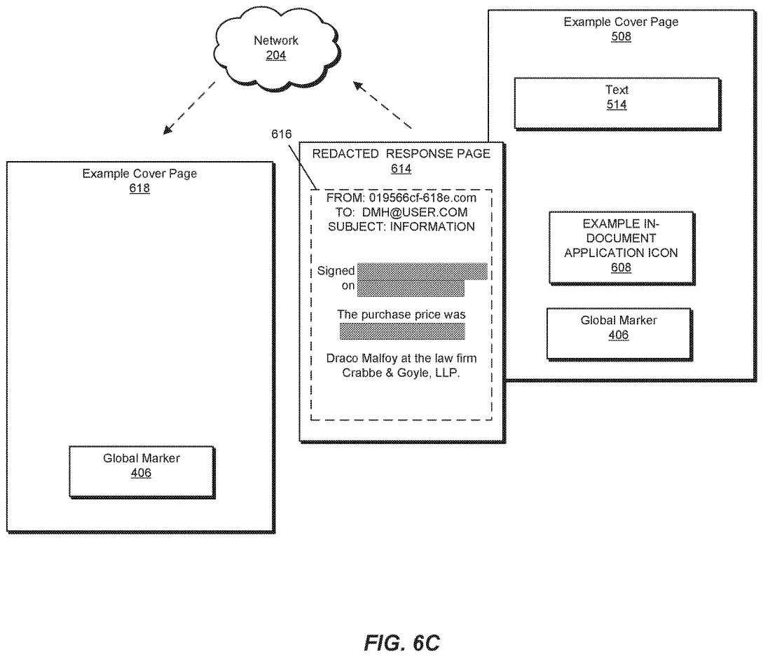

FIG. 6A illustrates the electronic document 102 implementing an in-document application (IDA) for facilitating an electronic mail communication exchange. For example, a user associated with the server 206 can interact with the document 102, e.g., via a display (not shown) communicatively coupled to the server 206, and select an in-document application icon 602. In response, the electronic document 102 initiates, via execution of one or more of the instructions 104, an IDA. The IDA is a software application that resides in and is part of the environment of the electronic document 102 and/or a cover page with which a user interacts. In some aspects, the electronic document 102 can output an example IDA email page 603 overlaying a part of the document 102 and can include example email content 604 such as, e.g., identification information of the requesting document (e.g., “From:”, “To:”, “Subject: ,” and so forth).

In some aspects, the example email content 604 can include various questions about another example cover page, e.g., the example cover page 508. For example, the user interacting with the example cover page 504 (e.g., a contract for the purchase of real property) may want to determine who signed the contract. To do so, he may select an in-document application icon 602, include a set of questions on the example IDA email page 603 and transmit the correspondence via the network 204. In some aspects, the user's selection of a send icon 606 initiates the transmission. Alternatively or additionally, upon the user selecting the in-document application icon 602, a draft email of an email application provided by well-known search engines (e.g., google, yahoo, Microsoft, etc.) may be output on the display (not shown) communicatively coupled to the server 206. The user may include the questions in the body of this email and utilize the email application to transmit the email directly to the cover page 508.

In this way, the electronic document 102 communicates directly with the example cover page 508 (1) via an example IDA email page 603 that overlays the document 102 and which is a part of the environment of the electronic document 102 and (2) via well-known email applications. In both instances, the embedded intelligence of the electronic document 102 (API 103) integrates the in-document application capabilities of the document 102, e.g., via interaction with the in-document application icon 602, with the example IDA email page 603 (e.g., a GUI within the environment of the document 102) and the email applications that are external to the environment of the document 102. The integration enables the electronic document 102 to directly query the example cover page 508. In some aspects, the electronic document 102 can simultaneously, sequentially, or in other ways, query multiple cover pages associated with different users and their respective devices.

FIG. 6B illustrates the example cover page 508 responding to the questions sent by the electronic document 102, as illustrated in FIG. 6A. In some aspects, the user of the example computing device 506 may view the correspondence that the example cover page 504 sent as being output on the example viewer 510 of the example computing device 506. For example, the user may see the correspondence as a digital page overlaying the example cover page 508 such that the questions included in the example email content 604 (FIG. 6A) may appear as part of a notification box output on, e.g., the bottom right of the example cover page 508. The notification box may appear in any other part of the example cover page 508.

In aspects, the example cover page may inform the user of a pending notification and select an example in-document application icon 608. In response, the example cover page may, automatically and without user intervention, generate a response. In other aspects, the example cover page may, entirely without user intervention, generate a response to the correspondence sent by the cover page 504. For example, the example cover page may generate an IDA email response page 610 that includes answers 612, namely that the real estate contract was signed by Mika, the purchase price of the property was $314,159.26, and outside counsel that reviewed the example cover page was Draco Malfoy at the law firm Crabbe & Goyle, LLP.

The example cover page may transmit the generated response, via the network 204, to the example cover page 504. Upon receipt, the document 102 may, upon execution of one or more of the instructions 104, output the responses for review by the requesting user. In aspects, the response may be output in the viewer 260 responsive to user selection of the In-Document Application Icon 602. In other aspects, the document 102 may, automatically and without user intervention, output the responses as part of a text box overlaying the document 102. Other forms of outputting the responses are also contemplated.

FIG. 6C illustrates outputting a redacted version of the answers 612 generated by the example cover page 508. For example, the owner of the electronic document 102 may have designated an assistant of one of the real estate brokers involved in the purchase and sale of the real estate property as an authorized user. As such, the electronic document 102 may propagate any changes made to document 102 to one or more example cover pages associated with and accessible by the assistant. However, the owner of the electronic document 102 may have designated the assistant as a non-critical party to the transaction. As such, the example cover page may generate a redacted response page 614, which includes partial answers 616. For example, the example cover page may, upon execution of one or more of the instructions 104, determine that the recipient associated with the example cover page 618—the assistant—is a non-critical party, and as such, should be sent a redacted version. Thus, the example cover page may transmit a redacted response page 614 that clearly displays the name of the person at the law firm that reviewed the contract, but redacts the information about the person that signed the document and the purchase price of the property.

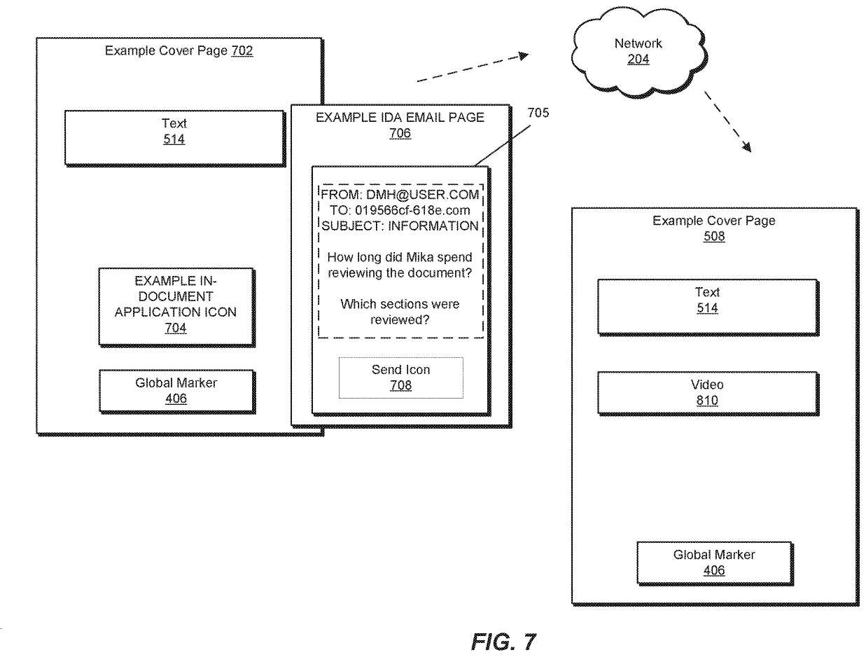

FIG. 7 illustrates an example cover page 702 implementing an in-document application (IDA) for facilitating another electronic mail exchange. The user of the example cover page 702 may want to determine how much time a particular individual spent reviewing the document and which sections of the document were reviewed. For example, the user of the example cover page 702—the lawyer that drafted the contract—may want to determine which contract clauses were reviewed in detail and which ones were reviewed briefly. In some aspects, the user may select the example In-Document Application Icon 704, draft a set of questions 705 as part of an example IDA email page 706, and select the send icon 708 to transmit the correspondence directly to example cover page 508.

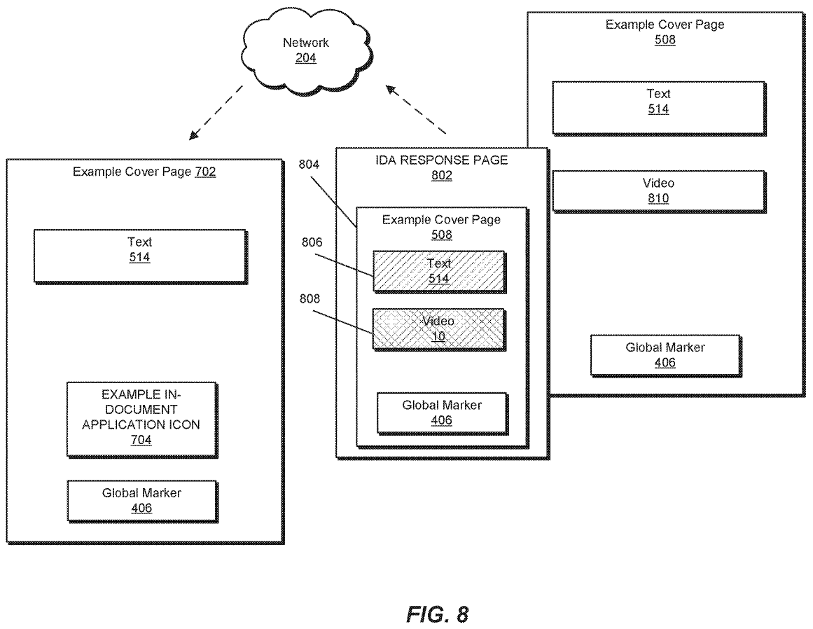

FIG. 8 illustrates a response generated by the example cover page 508. In some aspects, the example cover page 508, responsive to receiving the set of questions from the example cover page 702, as illustrated in FIG. 7, may generate, via execution of one or more of the instructions 104 of the electronic document 102, an IDA response page 802. For example, the IDA response page 802 may include response to the questions in text form. Alternatively or additionally, the example cover page may generate the IDA response page 802 to include a representation 804 of the example cover page that includes a heat map overlaying various parts of the example cover page 508. The heat map may include different colors and/or patterns overlaying various parts of the representation 804, with each color and/or pattern corresponding to a respective document review time or document review time interval.

For example, the example cover page may indicate, with a first pattern 806 on the heat map that a user spent, e.g., 50 minutes reviewing the text 514 and a second pattern 808 to indicate that the user spent approximately 5 minutes interacting with a video 810. It is noted that data representing the amount of time a user spent reviewing aspects of the example cover page can be presented in various ways. For example, the time or time interval may be displayed to a user when the user hovers a cursor over each of the first and second patterns 806 and 808 for a predefined time frame, e.g., a fraction of second, a few seconds, etc.

A smart document can be fundamentally defined by its association with a global marker that serves as a unique and immutable identifier. This global marker is not merely a reference point but a foundational element that ensures the document's authenticity and traceability throughout its lifecycle. The global marker is embedded within the document's metadata and is cryptographically secured to prevent tampering or alteration. It acts as a permanent identifier, linking the document to its original state and ensuring that any interaction with the document can be traced back to this immutable record. This concept is akin to a digital fingerprint, ensuring that the document remains unique and unchangeable, regardless of where it is stored or accessed. The immutability of the record is achieved through cryptographic techniques, such as hashing and digital signatures, which create a tamper-proof link between the document's content and its global marker.

The global marker can be understood as a special kind of URL, often referred to as a persistent URL (PURL). Unlike traditional URLs, which may change or become obsolete over time, a PURL is designed to remain constant, providing a reliable reference to the document regardless of changes in its storage location or access protocols. This ensures that the document can always be retrieved and verified using its global marker, eliminating ambiguity and enhancing trust. Systems such as digital object identifiers (DOIs) have been used in similar contexts to uniquely cite assets, such as academic papers or datasets. These systems provide a framework for ensuring that digital assets can be reliably referenced and accessed, even as they move across different platforms or repositories. The global marker in smart documents builds upon these principles, offering a more robust and secure mechanism for uniquely identifying and citing digital records.

The concept of the ultimate root of trust is central to the operation of smart documents, aligning with the principles of zero trust architecture. Zero trust emphasizes the need for rigorous security measures that assume no inherent trust in any system or user. Smart documents embody this philosophy by ensuring confidentiality, integrity, and availability. Confidentiality is achieved through client-side encryption, where sensitive information is encrypted before it is transmitted or stored. The system is designed such that even the servers hosting the document cannot retrieve the encrypted information, ensuring that only authorized users can access the content. Integrity is maintained through cryptographic commitments, which create a verifiable record of the document's state. These commitments ensure that the document cannot be altered without detection, even by the owner of the servers hosting it. Any attempt to modify the document would result in a mismatch between its cryptographic hash and the original hash, signaling tampering. Availability is guaranteed by designing the system to prevent unauthorized erasure of data. The document remains accessible and intact, regardless of external attempts to delete or corrupt it.

In some examples, a deduplication system may deduplicate electronic documents. Such a system may be a document hub, an enterprise application, or any other suitable application for deduplicating documents. In some examples, such a system may identify an electronic document having a globally unique identifier involves the process by which the system scans, indexes, or receives documents and examines their metadata or embedded properties to detect the presence of a unique, immutable identifier—such as a UUID (Universally Unique Identifier), GUID (Globally Unique Identifier), or another cryptographically secure address. This globally unique identifier serves as a digital fingerprint for the document, distinguishing it from all other documents, even if their content is similar or identical.

The deduplication system may operate within an enterprise content management platform, a cloud storage service, or a document management hub, continuously monitoring incoming, stored, or shared documents for such identifiers. Once the system identifies an electronic document with a globally unique identifier, it uses this identifier to perform a deduplication operation. Deduplication is the process of eliminating redundant copies of documents, ensuring that only a single authoritative version is retained within the system. For example, if multiple users upload or share the same contract, invoice, or report—each containing the same globally unique identifier—the system recognizes that these are not distinct documents but rather references to the same underlying record. The system then consolidates these instances, retaining only one copy and updating references or pointers so that all users and applications interact with the single authoritative version.

In a practical scenario, consider a large organization where employees frequently email attachments or upload files to shared drives. Without deduplication, the same document—such as a signed NDA or a quarterly financial report—may exist in dozens of locations, leading to confusion, wasted storage, and version control issues. By identifying the globally unique identifier embedded in each document, the deduplication system can automatically detect and remove redundant copies, ensuring that only one version is accessible and referenced throughout the organization.

Another example involves cloud-based collaboration platforms where multiple teams work on shared documents. If a project proposal is circulated and edited by different departments, each saving their own copy, the deduplication system can use the globally unique identifier to merge these copies, preserving the authoritative version and maintaining a unified audit trail. This not only saves storage space but also ensures that all collaborators are working with the most current and accurate document.

Deduplication using globally unique identifiers may also be helpful in regulatory and compliance contexts. For instance, in healthcare, patient records may be shared across departments or with external providers. The deduplication system ensures that each patient's record, identified by a unique identifier, is not duplicated, reducing the risk of inconsistent or outdated information being used in care decisions. Similarly, in legal or financial audits, deduplication guarantees that only the original, authoritative documents are reviewed, streamlining the audit process and enhancing trust in the records. In summary, identifying an electronic document with a globally unique identifier and using that identifier to perform deduplication enables organizations to maintain a single source of truth, reduce storage costs, eliminate confusion over document versions, and ensure data integrity across complex digital ecosystems. This process is essential for efficient document management, regulatory compliance, and seamless collaboration in modern enterprises.

Smart documents can be designed to eliminate the need for other kinds of documents by serving as a comprehensive system of record. This system of record consolidates all relevant information, interactions, and metadata within the document itself, creating a single authoritative source of truth. By embedding intelligence and cryptographic security directly into the document, smart documents ensure that they can fulfill all necessary functions without relying on external systems or supplementary records. This transformative approach simplifies workflows, enhances security, and reduces the risk of errors or inconsistencies.

An illustrative example of the root of trust can be seen in the case of Jill, a user interacting with a smart document. When Jill signs a contract using her digital signature, the document records her interaction as an immutable event. This event is cryptographically linked to Jill's identity, ensuring that her signature can be verified against her public key. The document also generates a hash commitment for the time and content of the interaction, creating a tamper-proof record of the event. If anyone attempts to alter Jill's signature or the associated metadata, the cryptographic commitments would immediately signal the discrepancy, preserving the integrity of the document.

Another example highlights the adaptability of smart documents in environments that only handle traditional formats, such as PDFs. When a smart document is sent to an agency that exclusively processes PDFs, it can generate a legacy-compatible version of itself, ensuring seamless integration with the agency's systems. This legacy version retains the document's core attributes, such as its global marker and cryptographic commitments, while presenting itself in a format that the agency can handle. When the agency interacts with the document, the smart document can identify that it is being accessed in a legacy format and provide appropriate responses or guidance to ensure compatibility. This capability demonstrates the versatility of smart documents, enabling them to bridge the gap between modern and traditional systems while maintaining their integrity and functionality.

In summary, smart documents represent a paradigm shift in digital record management, offering unparalleled security, traceability, and adaptability. Through the use of global markers, cryptographic commitments, and zero trust principles, these documents redefine the standards for authenticity, integrity, and availability. By consolidating all necessary functions within a single system of record, smart documents eliminate the need for supplementary records, streamlining workflows and enhancing trust. Whether interacting with users like Jill or integrating with legacy systems, smart documents exemplify the transformative potential of embedded intelligence and cryptographic security in modern digital ecosystems.

Furthermore, a smart document can be designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-world Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In many examples, a smart electronic document may include three elements, at minimum—data (e.g., content, audit trail, other metadata, etc.), executable code (e.g., an API), and a globally unique marker.

A smart electronic document that is uniquely addressable can be a technical solution to the persistent problem of managing and verifying digital documents, which are often prone to unauthorized modifications, fragmented audit trails, and inefficiencies in locating and referencing specific documents. This advanced document structure can incorporate immutable content and an immutable audit trail, both immutably connected to an immutable global identifier, ensuring that the document's content, history, and identity remain tamper-proof, trustworthy, and verifiable. The unique addressability of the document, enabled by its global identifier, can enable it to be reliably referenced and accessed across systems, eliminating ambiguity and ensuring consistency in workflows. The machine-readable design of the smart electronic document facilitates seamless integration with computational systems, enabling automated querying, validation, and processing of its data and interactions. Additionally, a smart electronic document can embed intelligence in the form of executable code, which enables it to autonomously enforce access permissions, execute workflows, and dynamically respond to user or system queries. This embedded intelligence transforms the document into a responsive and interactive entity capable of managing its lifecycle independently, providing a robust solution to the challenges of document security, traceability, and operational inefficiencies in modern digital ecosystems.

A smart electronic document with unique addressability can address one or more of the problems of data security, inefficient use of device hardware, and inefficient use of network systems associated with traditional PDFs and other documents by leveraging its immutable structure, embedded intelligence, and globally unique identifier. In terms of data security, the document's unique addressability ensures that each document can be reliably referenced and accessed without duplication or ambiguity, reducing the risk of unauthorized modifications or mismanagement. The immutable global identifier enables the document to enforce cryptographic commitments, ensuring that its content and audit trail remain tamper-proof and trustworthy.

Regarding device hardware, traditional PDFs may require significant computational resources for rendering, extracting data, and managing versions, often leading to inefficiencies and hardware strain. A smart electronic document can reduce these burdens by enabling lightweight, API-driven interactions that allow devices to query and retrieve specific data or metadata without processing entire files, improving hardware usage and improving operational efficiency. Similarly, network systems that handle PDFs often experience bandwidth inefficiencies due to the transmission of large, static files and duplicate versions. A smart electronic document addresses this by maintaining a single authoritative version that is universally accessible via its unique global identifier, enabling efficient data retrieval and reducing the need for redundant file transfers. This approach reduces network bandwidth usage, streamlines workflows, and ensures that documents are securely and efficiently managed across devices and systems, making unique addressability a cornerstone of the smart electronic document's infrastructure.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The following clauses show how aspects of this disclosure are technical solutions to technical problems and/or improve the functioning of a computing device.

Clause 1. A computer-implemented method, the computer-implemented method comprising: receiving a request addressed to a global marker of an electronic document, processing, by execution of the electronic document, the request, and responding to, by the execution of the electronic document, the request.

Clause 2. The computer-implemented method of clause 1, wherein the global marker is one of a uniform resource identifier (URI), uniform resource locator (URL), universally unique identifier (UUID), or a global identifier (GUID), and the responding to the request includes modifying, via the execution of the electronic document and using the computer, digital content included as part of the electronic document.

Clause 3. The computer-implemented method of clause 1 or 2, further comprising: receiving, from a device that is different from the computer, an additional request addressed to the global marker of the electronic document, processing, by execution of the electronic document, the additional request, and responding to, by the execution of the electronic document, the additional request.

Clause 4. The computer-implemented method of any of clauses 1-3, wherein the responding to the additional request comprises: modifying, by execution of the electronic document, additional digital content included as part of the electronic document, the modifying of the additional digital content being concurrent with the modifying of the digital content.

Clause 5. The computer-implemented method of any of clauses 1-4, wherein the digital content is different from the additional digital content.

Clause 6. The computer-implemented method of any of clauses 1-5, further comprising: updating, via the execution of the electronic document, the electronic document to include the digital content that is modified and the additional digital content that is modified.

Clause 7. The computer-implemented method of any of clauses 1-6, further comprising: facilitating, using a document management hub and via the execution of the electronic document, output of the electronic document including the digital content that is modified and the additional digital content that is modified on a display that is communicatively coupled to the computer.

Clause 8. The computer-implemented method of any of clauses 1-7, further comprising facilitating, using the document management hub and via execution of the electronic document, output of the electronic document including the digital content that is modified and the additional digital content that is modified on an additional display that is communicatively coupled to the device that is different from the computer.

Clause 9. A system comprising: at least one physical processor, physical memory comprising computer-executable instructions that, when executed by the at least one physical processor, cause the at least one physical processor to: receive a request addressed to a global marker of an electronic document, process, by execution of the electronic document, the request, and respond to, by the execution of the electronic document, the request.

Clause 10. The system of clause 9, wherein the computer-executable instructions, when executed by the at least one physical processor, cause the at least one physical processor to respond to the request by modifying, via the execution of the electronic document and using the at least one physical processor, digital content included as part of the electronic document.

Clause 11. The system of clause 9 or 10, wherein the computer-executable instructions, when executed by the at least one physical processor, further cause the at least one physical processor to: receive an additional request addressed to the global marker of the electronic document, process, by execution of the electronic document, the additional request, and respond to, by the execution of the electronic document, the additional request.

Clause 12. The system of any of clauses 9-11, wherein the computer-executable instructions, when executed by the at least one physical processor, cause the at least one physical processor to respond to the additional request by modifying, via execution of the electronic document and using a device that is different from the at least one processor, additional digital content included as part of the electronic document, the modifying of the additional digital content being concurrent with the modifying of the digital content.

Clause 13. The system of any of clauses 9-12, wherein: the global marker is one of a uniform resource identifier (URI), uniform resource locator (URL), universally unique identifier (UUID), or a global identifier (GUID).

Clause 14. The system of any of clauses 9-13, the digital content is different from the additional digital content; and

Clause 15. The system of any of clauses 9-14, wherein the computer-executable instructions, when executed by the at least one physical processor, further cause the at least one physical processor to: update, using a document management hub and via the execution of the electronic document, the electronic document to include the digital content that is modified and the additional digital content that is modified.

Clause 16. The system of any of clauses 9-15, wherein the computer-executable instructions, when executed by the at least one physical processor, further cause the at least one physical processor to: facilitate, using the document management hub and via the execution of the electronic document, output of the electronic document including the digital content that is modified and the additional digital content that is modified on a display that is communicatively coupled to the computer, and facilitate, using the document management hub and via the execution of the electronic document, output of the electronic document including the digital content that is modified and the additional digital content that is modified on an additional display that is communicatively coupled to the device that is different from the computer.

Clause 17. A non-transitory computer-readable medium comprising one or more computer-executable instructions that, when executed by at least one processor of a computing device, cause the computing device to: receive a request addressed to a global marker of an electronic document, process, by execution of the electronic document, the request, and respond to, by the execution of the electronic document, the request.

Clause 18. The non-transitory computer-readable medium of clause 17, wherein the one or more computer-executable instructions, when executed by the at least one processor, cause the at least one processor to respond to the request by modifying, via the execution of the electronic document and using the at least one processor, digital content included as part of the electronic document.

Clause 19. The non-transitory computer-readable medium of clause 17 or clause 18, wherein the one or more computer-executable instructions, when executed by at least one processor of a computing device, further cause the computing device to: receive an additional request addressed to the global marker of the electronic document, process, by execution of the electronic document, the additional request, and respond to, by the execution of the electronic document, the additional request.

Clause 20. The non-transitory computer-readable medium of any of clauses 17-19, wherein the one or more computer-executable instructions, when executed by the at least one processor, cause the at least one processor to respond to the additional request by modifying, via execution of the electronic document and using a device that is different from the at least one processor, additional digital content included as part of the electronic document, the modifying of the additional digital content being concurrent with the modifying of the digital content.

Clause 21. A method comprising identifying, at a system configured to deduplicate electronic documents, an electronic document having a globally unique identifier, and using, by the system, the globally unique identifier to perform a deduplication operation with respect to the electronic document.

1. A computer-implemented method, the computer-implemented method
comprising:
receiving a request addressed to a global marker of an electronic document;
processing, by execution of intelligence embedded within the electronic document, the request; and
responding to, by the execution of the intelligence embedded within the electronic document, the request.

2. The computer-implemented method of claim 1, wherein:
the global marker is one of a uniform resource identifier (URI),
uniform resource
locator (URL), universally unique identifier (UUID), or a globally unique identifier (GUID); and
the responding to the request includes modifying, via the execution of the electronic document and using a computer, digital content included as part of the electronic document.

3. The computer-implemented method of claim 2, further comprising:
receiving, from a device that is different from the computer, an additional request addressed to the global marker of the electronic document;
processing, by execution of the electronic document, the additional request; and responding to, by the execution of the electronic document, the additional request.

4. The computer-implemented method of claim 3, wherein the responding to the additional request comprises:
modifying, by execution of the electronic document, additional digital content included as part of the electronic document, the modifying of the additional digital content being concurrent with the modifying of the digital content.

5. The computer-implemented method of claim 4, wherein the
digital content
is different from the additional digital content.

6. The computer-implemented method of claim 5, further comprising:
updating, via the execution of the electronic document, the electronic document to include the digital content that is modified and the additional digital content that is modified.

7. The computer-implemented method of claim 6, further comprising:
facilitating, using a document management hub and via the execution of the electronic document, output of the electronic document including the digital content that is modified and the additional digital content that is modified on a display that is communicatively coupled to the computer.

8. The computer-implemented method of claim 7, further comprising:
facilitating, using the document management hub and via execution of the electronic document, output of the electronic document including the digital content that is modified and the additional digital content that is modified on an additional display that is communicatively coupled to the device that is different from the computer.

9. The method of claim 1, wherein the electronic document is configured to interact with an artificial intelligence agent using a specialized protocol.

10. The method of claim 9, wherein the specialized protocol comprises a machine communication protocol.

11. The method of claim 1, wherein the electronic document is configured to integrate with an artificial intelligence system by acting as an active participant in a workflow.

12. The method of claim 1, wherein the electronic document is configured to process a request from an artificial intelligence agent using embedded intelligence of the electronic document in a manner that provides a response tailored to a context of the request.

13. The method of claim 1, wherein the electronic document is configured to manage artificial intelligence agent access to the electronic document by autonomously evaluating permissions for one or more specific portions of the electronic document.

14. The method of claim 1, wherein the electronic document enables artificial intelligence analysis of engagement with the electronic document.

15. A system comprising:
at least one physical processor;
physical memory comprising computer-executable instructions that, when executed by the at least one physical processor, cause the at least one physical processor to:
receive a request addressed to a global marker of an electronic document;
process, by execution of intelligence embedded within the electronic document, the request; and respond to, by the execution of the intelligence embedded within the electronic document, the request.

16. The system of claim 15, wherein the computer-executable instructions, when executed by the at least one physical processor, cause the at least one physical processor to respond to the request by modifying, via the execution of the electronic document and using the at least one physical processor, digital content included as part of the electronic document.

17. The system of claim 16, wherein the computer-executable instructions, when executed by the at least one physical processor, further cause the at least one physical processor to:
receive an additional request addressed to the global marker of the electronic document;
process, by execution of the electronic document, the additional request; and respond to, by the execution of the electronic document, the additional request.

18. The system of claim 17, wherein the computer-executable instructions, when executed by the at least one physical processor, cause the at least one physical processor to respond to the additional request by modifying, via execution of the electronic document and using a device that is different from the at least one processor, additional digital content included as part of the electronic document, the modifying of the additional digital content being concurrent with the modifying of the digital content.

19. The system of claim 15, wherein:
the global marker is one of a uniform resource identifier (URI),
uniform resource
locator (URL), universally unique identifier (UUID), or a globally unique identifier (GUID).

20. The system of claim 18, wherein the digital content is different from the additional digital content.

21. The system of claim 20, wherein the computer-executable instructions, when executed by the at least one physical processor, further cause the at least one physical processor to:
update, using a document management hub and via the execution of the electronic document, the electronic document to include the digital content that is modified and the additional digital content that is modified.

22. The system of claim 21, wherein the computer-executable instructions, when executed by the at least one physical processor, further cause the at least one physical processor to:
facilitate, using the document management hub and via the execution of the electronic document, output of the electronic document including the digital content that is modified and the additional digital content that is modified on a display that is communicatively coupled to the system; and
facilitate, using the document management hub and via the execution of the electronic document, output of the electronic document including the digital content that is modified and the additional digital content that is modified on an additional display that is communicatively coupled to the device that is different from the system.

23. A non-transitory computer-readable medium comprising one or more computer-executable instructions that, when executed by at least one processor of a computing device, cause the computing device to:
receive a request addressed to a global marker of an electronic document;
process, by execution of intelligence embedded within the electronic document, the request; and respond to, by the execution of the intelligence embedded within the electronic document, the request.

24. The non-transitory computer-readable medium of claim 23, wherein the one or more computer-executable instructions, when executed by the at least one processor, cause the at least one processor to respond to the request by modifying, via the execution of the electronic document and using the at least one processor, digital content included as part of the electronic document.

25. The non-transitory computer-readable medium of claim 24, wherein the one or more computer-executable instructions, when executed by at least one processor of a computing device, further cause the computing device to:
receive an additional request addressed to the global marker of the electronic document;
process, by execution of the electronic document, the additional request; and respond to, by the execution of the electronic document, the additional request.

26. The non-transitory computer-readable medium of claim 25, wherein the one or more computer-executable instructions, when executed by the at least one processor, cause the at least one processor to respond to the additional request by modifying, via execution of the electronic document and using a device that is different from the at least one processor, additional digital content included as part of the electronic document, the modifying of the additional digital content being concurrent with the modifying of the digital content.

27. A method comprising:
identifying, at a system configured to deduplicate electronic documents, an electronic document having a globally unique identifier; and
using, by the system, the globally unique identifier to perform a deduplication operation with respect to the electronic document.
